(19) United States
(12) Patent Application Publication
(10) Pub. No.: US 2005/0091990 A1
(43) Pub. Date: May 5, 2005

(54) Use of welds for thermal and mechanical connections in cryogenic vacuum vessels

(76) Inventors: Charles F. Carter III, Wilmington, DE (US); James D. McCambridge, Swarthmore, PA (US); Robert J. Small, Folsom, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/896,707

(22) Filed: Jul. 22, 2004

Related U.S. Application Data
(60) Provisional application No. 60/496,845, filed on Aug. 21, 2003.

(51) Int. Cl. F17C 5/02; F25B 19/00

(52) U.S. Cl. 62/47.1

(57) ABSTRACT

This invention relates to the use of welds to provide improved thermal and mechanical connections in a cryogenic vacuum vessel. Welds provide strong, reliable connections in this environment.

This application claims the benefit of U.S. Provisional Application No. 60/496,845, filed Aug. 21, 2003.

### FIELD OF THE INVENTION

This invention relates to the use of welds to provide improved thermal and mechanical connections in a cryogenic vacuum vessel.

### BACKGROUND OF THE INVENTION

Cryogenic vacuum vessels are used in a wide range of applications in which it is advantageous or necessary to have electronic circuits, sensors or other devices located in a vacuum at cryogenic temperatures, typically of the order of 150K or lower.

The discovery and use of high temperature superconductor (HTS) materials that superconduct at temperatures of 77K or higher have increased the need for vacuum vessels that permit operation at cryogenic temperatures. They have been used in various industrial, medical, research and military applications.

As a result of the growth in the telecommunications industry, one of the fastest growing commercial applications has been in the area of electronics and associated microwave engineering. In this area, an essential part of many devices is the filter element. HTS filters have significant advantages in insertion loss and selectivity due to the extremely low radio frequency (RF) loss in HTS materials.

Amplifiers and other circuit components, as well as one or more HTS filters, can be contained within the cryogenic vacuum vessel. One such application is a cryogenic receiver front-end in which cryoelectronic components such as RF filters and low-noise amplifiers are typically contained within the cryogenic vacuum vessel.

The cryogenic vacuum vessel is evacuated to a high vacuum in order to more readily maintain the components contained therein, e.g. the cryoelectronic components, at cryogenic temperatures. A cyrocooler provides the cooling necessary to achieve cryogenic temperatures and is in close proximity to the cryogenic vacuum vessel. Typically, a cold finger extends from the cryocooler through an opening provided in the wall of the cryogenic vacuum vessel and into the interior of the cryogenic vacuum vessel. The cold finger makes intimate contact with a cold plate, a good thermal conductor, to which the cryoelectronic components can be attached and thereby maintained at the desired temperature.

Typically, solder is used to make the connection between the cold finger and the cold plate. Solder provides good thermal conductivity and the ability to adjust the height of the cold plate within the cryogenic vacuum vessel. However, vibration of the cryoelectronic components can cause cracks in the solder that interrupt the thermal path between the cold finger and the cold plate. In addition, brackets to secure and hold various cryoelectronic components such as thermal/infrared heat/radio frequency shields, HTS filters and amplifiers, the cold plate and other components in their respective positions in the cryogenic vacuum vessel are typically attached to the cryogenic vacuum vessel and to one another with screws. Machining small screw holes is expensive, and it has been found that these screws can back out of their screw holes in this environment and in so doing do not provide the reliable attachments required.

An object of the present invention is to provide, in a cryogenic vacuum vessel, improved thermal and mechanical connections for reliably attaching the cold plate to the cold finger, and attaching various components therein to the cryogenic vacuum vessel and to one another.

### SUMMARY OF THE INVENTION

This invention provides a cryogenic device having a vacuum vessel, a cryocooler, a cold plate located in the vacuum vessel and a cold finger extending from the cryocooler into the vacuum vessel, wherein the cold finger is welded to the cold plate.

This invention provides a cryogenic device having a vacuum vessel, a cryocooler and a first component located in the vacuum vessel, wherein the first component is welded to the vacuum vessel.

This invention provides a cryogenic device having a vacuum vessel, a cryocooler and first and second components located in the vacuum vessel, wherein the first component is welded to the second component.

This invention provides a cryogenic device having a vacuum vessel, a cryocooler and a first component located in the vacuum vessel, wherein the first component is held in position by one or more brackets, and at least one bracket is welded to the vacuum vessel or to a second component.

Any of the cryogenic devices of this invention may, for example, be a cryogenic receiver front-end.

Welds provide strong, reliable thermal/mechanical connections in this environment.

### DETAILED DESCRIPTION OF THE PREFERRED EMBODIMENTS

This invention provides in a cryogenic vacuum vessel reliable thermal and mechanical connections for attaching the cold plate to the cold finger, and attaching various components contained therein to the cryogenic vacuum vessel and to one another.

The connection between the cold finger and the cold plate is a critical one. It must provide a good thermal path between the cold finger and the cold plate so that components attached to the cold plate are maintained at the desired cryogenic temperature, and it must provide a strong mechanical bond that is not subject to cracking. A weld provides such properties. A weld for such purpose can be created by any welding technology, e.g. by laser welding, tack welding, or plasma welding.

In addition, various components of the vacuum vessel may be attached to the vacuum vessel or to one another. These attachments are used to hold the various components in their proper positions within the vacuum vessel and, in some instances, to provide electrical connections from one component to another. In this invention, these attachments are also provided by a weld. For example, one such component is the cold plate, which must be held in a fixed position to avoid impairing the connection between it and the cold finger.

When it is desired to hold a component in its proper place, the component can be directly welded to the vacuum vessel or to another component, e.g. the cold plate. Alternatively, however, the component can be held in position by one or more brackets that are welded to the vacuum vessel or to another component, e.g. the cold plate. Preferably, all such brackets are welded to the vacuum vessel or to another component. Connections that serve as electrical connections are made by directly welding a connecting member to the cryoelectronic components to be connected.

As an example of the above, in the case of a cryogenic front-end receiver, cryoelectronic components such as HTS filters and, in some instances, amplifiers must be held in intimate contact with the cold plate and must have electrical connections to other circuit components.

1. A cryogenic device comprising a vacuum vessel, a cryocooler, a cold plate located in the vacuum vessel and a cold finger extending from the cryocooler into the vacuum vessel, wherein the cold finger is welded to the cold plate.

2. The cryogenic device of claim 1 wherein the cold plate is welded to the vacuum vessel.

3. A cryogenic device comprising a vacuum vessel, a cryocooler and a first component located in the vacuum vessel, wherein the first component is welded to the vacuum vessel.

4. The cryogenic device of claim 3 which further comprises a cold plate located in the vacuum vessel wherein the cold plate is welded to the vacuum vessel.

5. The cryogenic device of claim 3 which further comprises a second component located in the vacuum vessel wherein the second component is welded to the first component.

6. The cryogenic device of claim 5 wherein the second component is a cold plate.

7. The cryogenic device of claim 5 wherein the first component is a cold plate, and the second component is an HTS filter.

8. A cryogenic device comprising a vacuum vessel, a cryocooler and first and second components located in the vacuum vessel, wherein the first component is welded to the second component.

9. The cryogenic device of claim 8 wherein the first component is a cold plate.

10. The cryogenic device of claim 9 wherein the second component is an HTS filter.

11. The cryogenic device of claim 3 which further comprises a cold finger extending from the cryocooler into the vacuum vessel, wherein the first component is a cold plate, and the cold finger is welded to the cold plate.

12. A cryogenic device comprising a vacuum vessel, a cryocooler and a first component located in the vacuum vessel, wherein the first component is held in position by one or more brackets, and at least one bracket is welded to the vacuum vessel or to a second component.

13. The cryogenic device of claim 12 wherein the first component is a cold plate.

14. The cryogenic device of claim 13 wherein all brackets are welded to the vacuum vessel.

15. The cryogenic device of claim 12 wherein all brackets are welded to the vacuum vessel or to the second component.

16. The cryogenic device of claim 12 wherein the first component is an HTS filter and the second component is a cold plate.

17. The cryogenic device of any one of claims 1, 3 or 12 wherein the cryogenic device is a cryogenic receiver front-end.
